(19) United States
(12) Patent Application Publication
(10) Pub. No.: US 2006/0101122 A1
(43) Pub. Date: May 11, 2006

(54) Cell-phone terminal device, mail processing method, and program

(75) Inventor: Kenji Ishii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/059,470

(22) Filed: Feb. 16, 2005

(30) Foreign Application Priority Data
Nov. 10, 2004 (JP) 2004-325940

(51) Int. Cl. G06F 15/16

(52) U.S. Cl. 709/206

(57) ABSTRACT

The mail application prepares and transmits a mail of the multi-part format comprising a main mail text, any or both of an HTML part permitting image pasting into the main mail text and a text part comprising only a main mail text, and a selective attached file permitting image attachment. The image contents processing unit selects an image for screen display and instructs preparation of a mail. The mail deploying unit 42 performs inline attachment of pasting an image to the main mail text upon receipt of an instruction to prepare a mail from the image contents processing unit 34, to make it possible to deploy a mail preparing screen.

This application is a priority based on prior application No. JP 04-52329, filed Nov. 10, 2004, in Japan.

### BACKGROUND OF THE INVENTION

1. Field of the Invention

The present invention relates to a cell-phone terminal device, a mail processing method and a program for preparing and transmitting a mail of the multi-part format comprising an HTML part permitting image pasting into a main mail text, a text part and an attached file, and particularly, to a cell-phone terminal device, a mail processing method and a program for preparing a mail by selecting an image from an image contents application.

2. Description of the Related Art

In the conventional cell-phone services, an image photographed by a camera can be transmitted by attaching to a text-format mail. Preparation of such a mail attached with an image is accomplished through selection of an image by opening an image content application such as a camera in menu selection on the mail preparing screen. There is provided a function of deploying a mail preparing screen of a mail automatically attached with a selected image and transmitting the thus prepared mail by pressing the software key for mail preparation for the image selected from the image content application.

More recently, a new cell-phone service has been started by adopting a W-CMDA method permitting high-speed transfer in a broadband. In this cell-phone service, an HTML mail is provided, which can be transmitted, in addition to attachment of a still image photographed by a camera or the like to the main mail text, by an inline attachment of pasting to the main mail text.

The HTML mail is described in the MIME format including an HTML part. In addition to simple attachment to the image mail, inline attachment of pasting the image into the HTML main mail text can be used.
[Patent Document 1] Japanese Unexamined Patent Application Publication No. 2001-325196
[Patent Document 2] Japanese Unexamined Patent Application Publication No. 2002-116975

### SUMMARY OF THE INVENTION

In such a conventional HTML mail, however, the main mail text is prepared by opening an HTML mail preparing screen, and during or after preparation of the main mail text, an image content application such as a camera is opened from the menu to select an image. This results in a problem of much time and labor consumed for selection of the image to be pasted to the mail.

Particularly, when pasting an image during preparation of a mail, it is the usual practice to first determine for example a picture of a tour relevant to the subject, but to select an image to be actually pasted while watching pictures by opening the image content application. Since the image to be pasted is not selected in advance, preparation of the mail having the pasted image takes much time and labor.

A user may, when selecting a picture by opening an image content application, want to transmit a selected image simple-attached to the mail, not an image pasting to the main mail text. In such a case, on an HTML mail preparing screen, the image is automatically pasted onto a designated position upon completion of the image selection, and the inline attachment of the image cannot be changed to the simple attachment on the way of image selection.

The present invention has an object to provide a cell-phone terminal device, a mail processing method and a program which make it possible to easily carry out mail preparation through image pasting based on inline attachment to the HTML main mail text, not limited to the main preparation of simple attachment from a image contents application.

FIG. 1 is a descriptive view of the principle of the present invention. The present invention provides a cell-phone terminal device such as a cell phone. The cell-phone terminal device of the present invention comprises:

A mail processing unit (mail application) which prepares and transmits a mail of the multi-part format comprising a main mail text, any or both of an HTML part permitting pasting of an image and a text part comprising a main mail text alone, and selective attached files permitting attachment of an image;

an image processing unit (image contents processing unit) which selects an image for screen display and instructs preparation of the mail; and

a mail deploying unit which can deploy a mail preparing screen by performing an inline attachment of pasting the image to the main mail text upon receipt of the instruction to prepare a mail from the image processing unit.

Furthermore, the present invention has a storage unit which can register an inline attachment in preference which affords a preference to inline attachment or a simple attachment in preference which affords a preference to simple attachment of simply attaching the image to the main mail text; wherein:

When any of the inline attachment in preference and the simple attachment in preference is registered in advance, the mail deploying unit deploys a mail preparing screen corresponding to the details of preference of the prior registration.

In a deployed state of the mail preparing screen by the mail deploying unit, the mail processing unit makes it possible for a mail preparing screen of inline attachment to be switched over to a mail preparing screen of simple attachment upon selecting mail switching from the menu.

The present invention provides a mail preparing method of a cell-phone terminal device. More specifically, the present invention provides a mail processing method of a cell-phone terminal device which prepares and transmits an HTML mail of a multi-part format comprising a main mail text, any or both of an HTML part permitting pasting of an image and a text part comprising a main mail text alone, and selective attached piles permitting attachment of an image. This mail processing method comprises:

an image processing step which selects an image for screen display and instructs preparation of the mail; and

a mail deploying step which, upon receipt of an instruction to prepare a mail from the image processing step performs an inline attachment of pasting the image onto the main text for deployment of a mail preparing screen.

The present invention provides a program for mail processing which is to be executed by a computer of a cell-phone terminal device. The program of the present invention causes a computer of a cell-phone terminal device which prepares and transmits an HTML mail of a multi-part format comprising a main mail text, any or both of an HTML part permitting pasting of an image and a text part comprising a main mail text alone, and selective attached files permitting attachment of an image to execute:

an image processing step which selects an image for display on a screen and instructs preparation of the mail; and

a mail deploying step which, upon receipt of an instruction to prepare a mail from the image processing step, performs an inline attachment of pasting the image onto the main mail text for deployment of a mail preparing screen.

Details of the main processing method and the program of the cell-phone terminal device of the present invention are the same as those of the cell-phone terminal device of the present invention.

According to the present invention, it is possible to select, after selecting an image from an image contents application such as a camera, an image viewer or a browser, whether the selected image is to be pasted to the main mail text by inline attachment, or to be attached to the main mail text as a simple attachment, thus making it possible to achieve a higher degree of freedom for the selection by the user.

By registering automatic selection in advance by the user, it is possible to rapidly deploy a mail preparing screen of inline attachment or simple attachment set in preference without the need for a selecting operation, leading to an easier operation.

In the deployed state of the mail preparing screen of inline attachment, the screen is switched over to a mail preparing screen of simple attachment by selecting mail switching from the menu. In the deployed state of the mail preparing screen of simple attachment, in contrast, the screen is switched over to a mail preparing screen of inline attachment having an image pasted to the main mail text. Even after deploying the main screen, the user can freely select image pasting or image attachment.

The above and other objects, features, and advantages of the present invention will become more apparent from the following detailed description with reference to the drawings.

### BRIEF DESCRIPTION OF THE DRAWINGS

FIG. 1 is a descriptive view of a cell phone to which the HTML mail preparing processing of the present invention is applicable;

FIG. 2 is a block diagram of the functional configuration of the present invention in the cell phone shown in FIG. 1;

FIGS. 3A to 3C are descriptive views of the MIME mail format of the multi-part format in the cell phone of the present invention;

FIG. 4 is a descriptive view of the mail deploying processing according to the present invention;

FIG. 5 is a flowchart of the mail deploying processing according to the present invention corresponding to FIG. 4;

FIG. 6 is a descriptive view of the mail deploying processing according to the present invention which dialog-selects the template;

FIGS. 7A and 7B are flowchart of the mail deploying processing according to the present invention corresponding to FIG. 6;

FIG. 8 is a descriptive view of the mail deploying processing according to the present invention which automatically selects an HTML mail and a text mail;

FIGS. 9A and 9B are flowcharts of the mail deploying processing according to the present invention corresponding to FIG. 8;

FIG. 10 is a descriptive view of the mail deploying processing according to the present invention capable of switching over the mail deploying screen between the HTML mail and the text mail;

FIGS. 11A and 11B are flowcharts of the mail deploying processing according to the present invention corresponding to FIG. 10; and

FIGS. 12A and 12B are flowcharts of the mail deploying processing according to the present invention, which automatically changes the image size on the mail preparing screen.

### DETAILED DESCRIPTION OF THE PREFERRED EMBODIMENTS

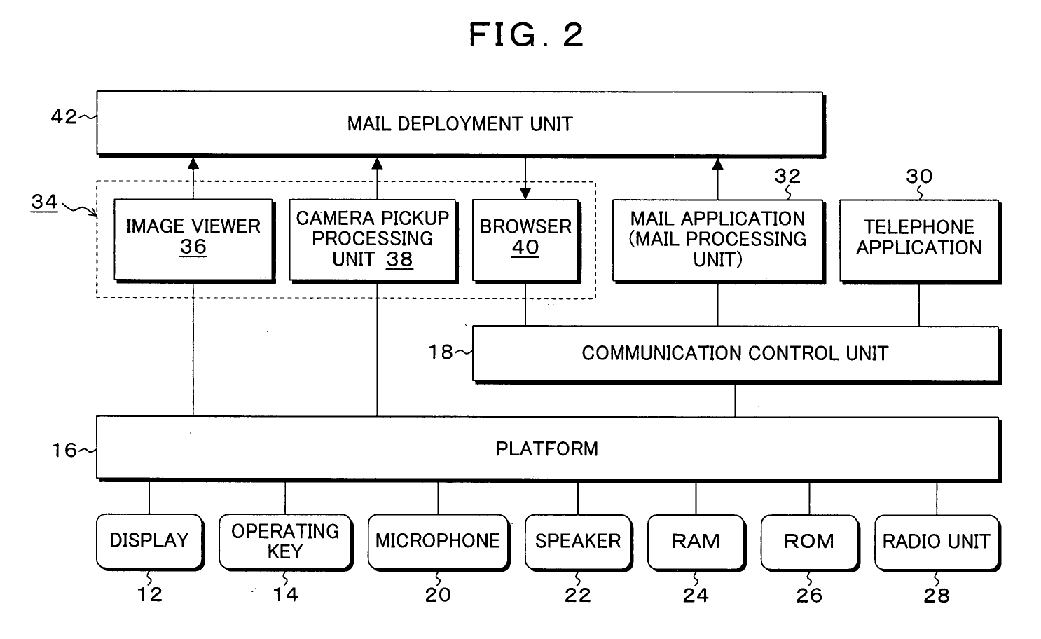

FIG. 2 is a descriptive view illustrating a cell phone as an example of the cell-phone terminal device applied for the HTML mail preparing processing of the present invention. In FIG. 2, a cell phone 10 comprises a display 12 and an operating key 14. For example, a liquid crystal color display is used as a display 12.

The operating keys 14 include “0” to “9” numbered keys, and in addition, above the numbered keys, physical keys 14-1 to 14-4 carrying out switch operations corresponding to software keys (hereinafter referred to as “soft keys”) displayed on the display 12 are arranged, with a decision key 15 provided in between. The decision key 15 is used for deciding operation by on and off, and has a seesaw structure

which permits scrolling selection of selection items of diialog on the display 12 by pressing the upper or lower portion thereof.

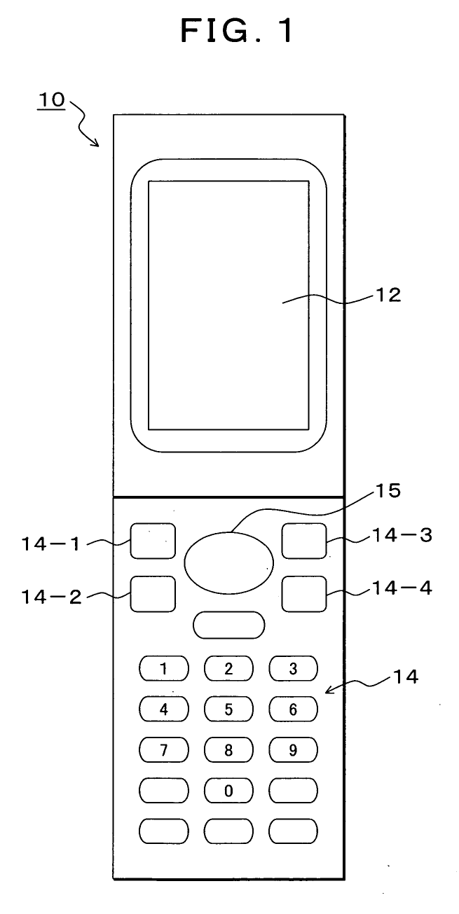

FIG. 2 is a block diagram of the functional configuration of the present invention in the cell phone shown in FIG. 1. In FIG. 2, the cell phone 10 has a platform 16 including an OS, a file system and the like, and a communication control unit 18 performing mobile communication of the W-CSMA method. The platform 16 comprises a display 12, an operating key 14, a microphone 20, a speaker 22, an RAM 24, an ROM 26 and a radio unit 28.

For the platform 16, a telephone application 30, a mail application 32 serving as a mail processing unit, and a browser 40 are provided via the communication control unit 18. Also for the platform 16, an image viewer 36 and a camera photographing processing unit 38 are provided. The image viewer 36, the camera photographing unit 38 and the browser 40 form an image content processing unit 34 which functions as an image processing unit.

For the image content processing unit 334 and the mail application 32, a mail deploying unit 42 is provided anew in the present invention.

The mail application 32 serving as a mail processing unit has a function of preparing and transmitting an HTML mail. The HTML mail is of the multi-part format composed of an HTML part and an image part, or an HTML part, an image part and a text part, in which an image can be pasted onto the main mail text of the HTML part. Not the HTML mail, but a mail having an attached image by simple attachment to the mail comprising a text part alone may be prepared and transmitted.

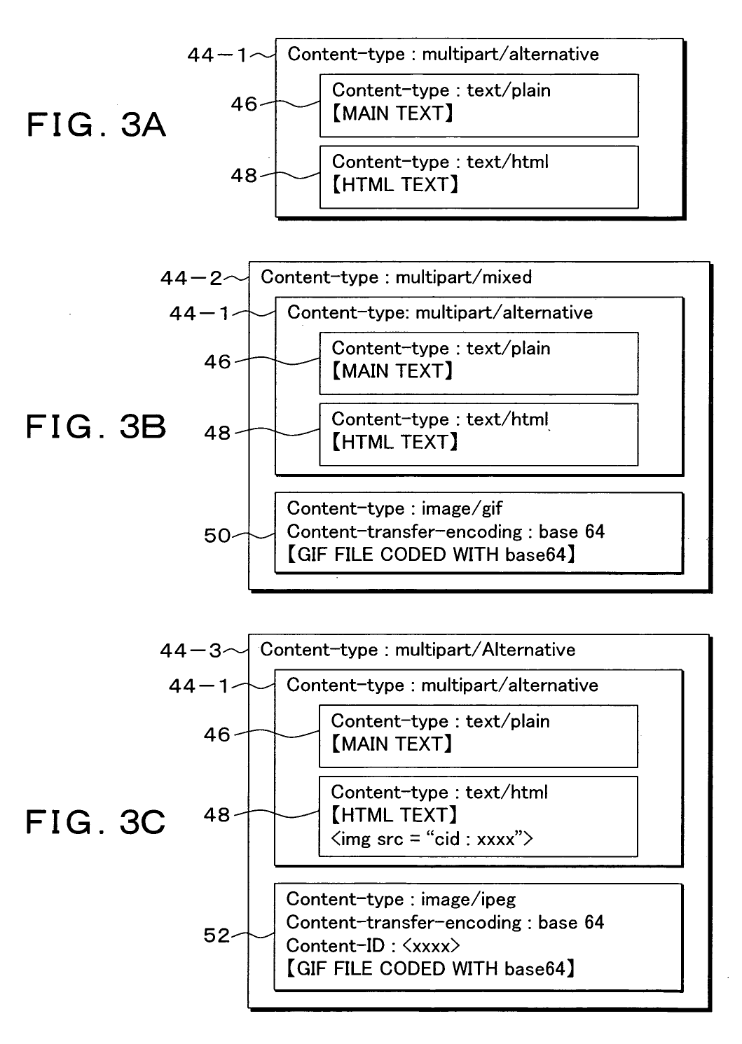

FIG. 3 is a descriptive view of the MIME mail format of the multi-part type in the cell phone 10 of the present invention. FIG. 3(A) shows an MIME format without an attached file 44-1, comprising a text part 46 and an HTML part 48. The text part 46 stores only the main text, and the HTML part stores only the HTML main text in this case.

FIG. 3(B) is a descriptive view of an HTML format 44-2 with an attached file. In this case, an attached file 50 is simple-attached to an MIME format 44-1 without an attached file, having a text part 46 and an HTML part 48 as in FIG. 2(A). The attached file 50 is an image, having a simple-attached GIF file coded with base64.

FIG. 3(C) is a descriptive view of an MIME format 44-3 with an inline image in which the image is pasted to the HTML main text. In this case, an inline file 52 is added to the MIME format 44-1 without an attached file including the same text part 46 and HTML part 48 as those shown in FIG. 3(A).

The inline file 52 is an image file, and has a JPEG file coded with base64 attached thereto in this case. A script text 48-1 for pasting an image <img src =“cid: xxxx”> is described in the HTML part. A content ID “content-ID: <xxxx>” is described in the inline file 52. Therefore, the image designated by the content ID is pasted at a position specified by the script text of the HTML part 48.

Referring again to FIG. 2, the image viewer 36, the camera photographing processing unit 38 and the browser composing the image content processing unit 34 activates respective applications, and upon selecting an image therefrom and screen-displaying the image on the display 12, display the soft key instructing preparation of a new HTML mail on the screen.

When the soft key is operated in a selected state of an image by any of the applications of the image content processing unit 34, the mail deploying unit 42 first displays a dialog for selecting the inline attachment of pasting the image onto the main mail text or the simple attachment of attaching the image to the main mail text. For the displayed dialog, the mail preparing screen in which the selected image is pasted is deployed by the mail application when inline attachment is selected. When simple attachment is selected, the mail preparing screen in which the selected image is simple-attached is deployed in the mail application 32.

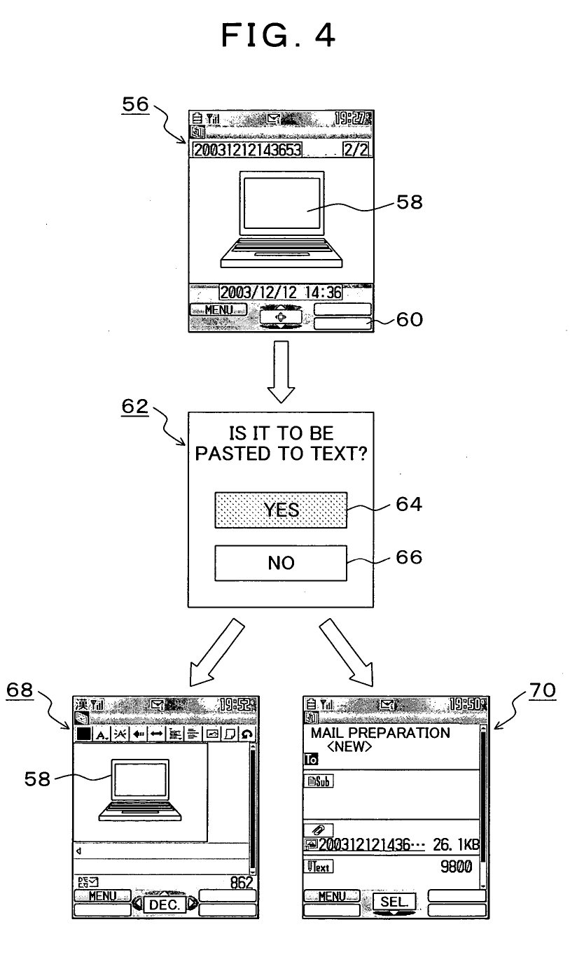

FIG. 4 is a descriptive view of the mail deployment processing by the mail deploying unit 42 shown in FIG. 2. In FIG. 3, a selected image 56 to be used for the mail is determined, as shown in the image selecting screen 58, by activating, for example, the image viewer 36 shown in FIG. 2. At right bottom of the image selecting screen 58 deployed by the image viewer 36, the soft key 60 for preparing a mail are displayed. As the soft keys, apart from the soft key 60 for mail preparation, the soft key for menu and the soft key for compiling are displayed.

The soft key 60 corresponds to the physical key 14-4 of the cell phone 10. When it is desired to prepare a mail by using a selected image 56 of such an image selecting screen 58, the soft key 10 is operated. More specifically, the physical key 14-4 shown in FIG. 1 corresponding to the soft key 60 is operated. By the application of this soft key 60, the dialog 62 indicated by an arrow is displayed.

A message “Is it to be pasted in the main text?” is displayed for selection on the dialog 62, with an inline attachment selection window 64 having a heading “Yes” and a simple attachment selection window 66 having a heading “No” are displayed thereunder. The dialog 62 is currently in the state of selection of the inline attachment selection window 64. By pressing the definite key 15 of the cell phone 10 shown in FIG. 1 in this state, the HTML mail preparing screen 68 shown at left bottom is opened, and at the same time, the selected image 56 is pasted in the main mail text of the HTML mail preparing screen 68.

On the other hand, when the simple attachment selection window 66 is selected by the seesaw operation by pressing the underside of the decision key 15 shown in FIG. 2 for the dialog 62, and the decision key 15 is pressed down, the text mail preparing screen 70 shown at right bottom is displayed.

The HTML mail preparing screen 68 corresponds to the MIME format 44-3 with an inline image shown in FIG. 3(C), and the text mail preparing screen 70 corresponds to the MIME format 44-2 with an attached file shown in FIG. 3(B).

In the cell phone of the present invention, as described above, in the attached state of any of the applications provided in the image content processing unit 34 such as an image viewer 36, a camera photographing processing unit 38 and a browser 40, the display 62 is displayed by pressing the soft key 60 after selecting an image to be used in the mail. Whether to paste the image to the main mail text or to attach the same to the main mail text is selected from the dialog 62. When this selection becomes definitive, the HTML mail preparing screen 68 is displayed in the state having the selected image 56 pasted thereto. After the decision of the pasted image, the user can prepare the main mail text and transmit the same.

On the other hand, when the simple attachment of the image is selected, the text mail preparing screen is opened. At this stage of operation, the selected image is already in the simple-attached state, and after determination of image attachment, a main mail text can be prepared and transmitted.

In the mail preparing processing shown in FIG. 4, it is possible to select and deploy the HTML mail preparing screen 68 or the text mail preparing screen 70 and deploy the same by use of the soft key. For this purpose, it is necessary to provide two soft keys for NTML mail and for text mail on the image selecting screen 58. Since the soft keys which can be used in a cell phone are limited in number, for the image selecting screen 58 in the present invention, only one soft key 60 is provided for mail preparation. The number of soft keys used is reduced by causing the dialog 62 opened by pressing the soft key 60 to accomplish selection between HTML mail and text mail.

When the HTML mail preparing screen 68 is opened in FIG. 4, the selected image 56 is pasted at a position specified in the main mail text. If the main mail text does not contain a specification of a pasting position, the image is pasted last.

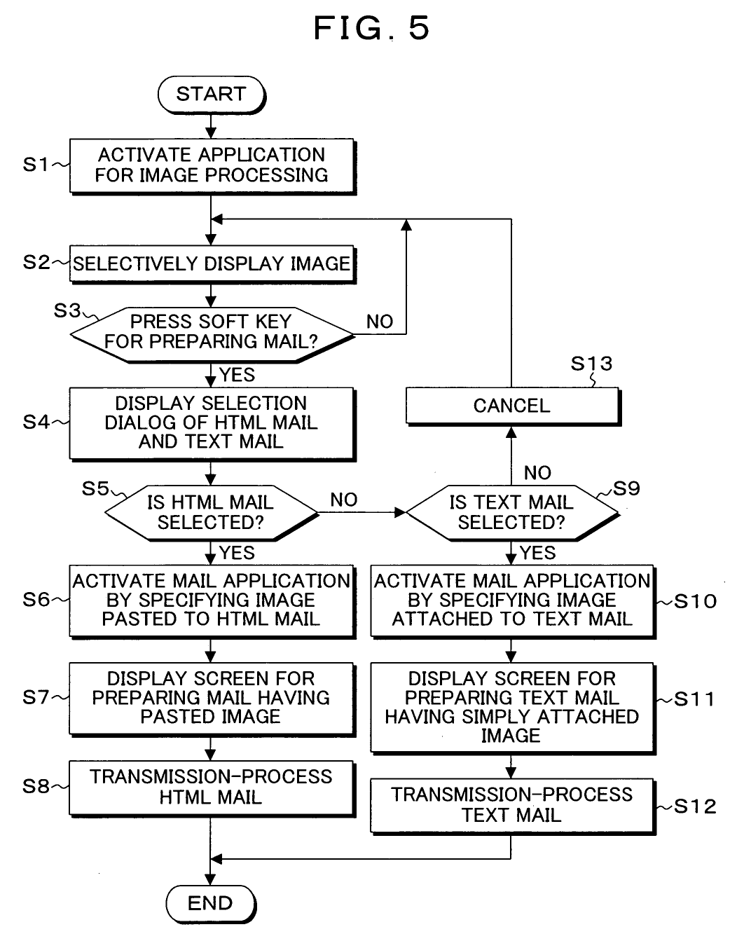

FIG. 5 is a flowchart of the mail deploying processing according to the present invention corresponding to FIG. 4. In FIG. 5, in a state in which the image processing application is activated in step S1, an image to be used for the mail is selected nd displayed in step S2. Then in step S3, is checked whether or not the mail preparing soft key 60 has been pressed down.

Upon determining pressing of the spot key 60 for mail preparation, the process advances to step S4 to display the selection dialog between HTML mail and text mail. Upon display of this dialog, if the selection of HTML mail is determined in step S5, the process goes to step S6: an image to be pasted in the HTML mail is designated and the mail application 32 is activated. The activated mail application 32 displays a preparing screen of the HTML mail in which an image has been pasted in step S7. In step S8, a transmitting processing is carried out after preparation of the main text of the HTML mail.

On the other hand, when text mail is selected in step S4, the process advances from step S5 to step S9 in which selection of the text mail is determined. In step S10, a simple-attached image to the text mail is specified, and the mail application is activated. In step S11, a mail preparing screen of a text mail having the image attached thereto is displayed. In step S12, a text mail main text is prepared, and transmitted.

When a canceling operation is carried out in the dialog for image selection, display of the dialog is cancelled in step S13, and the process returns to selection display of the image in step S2.

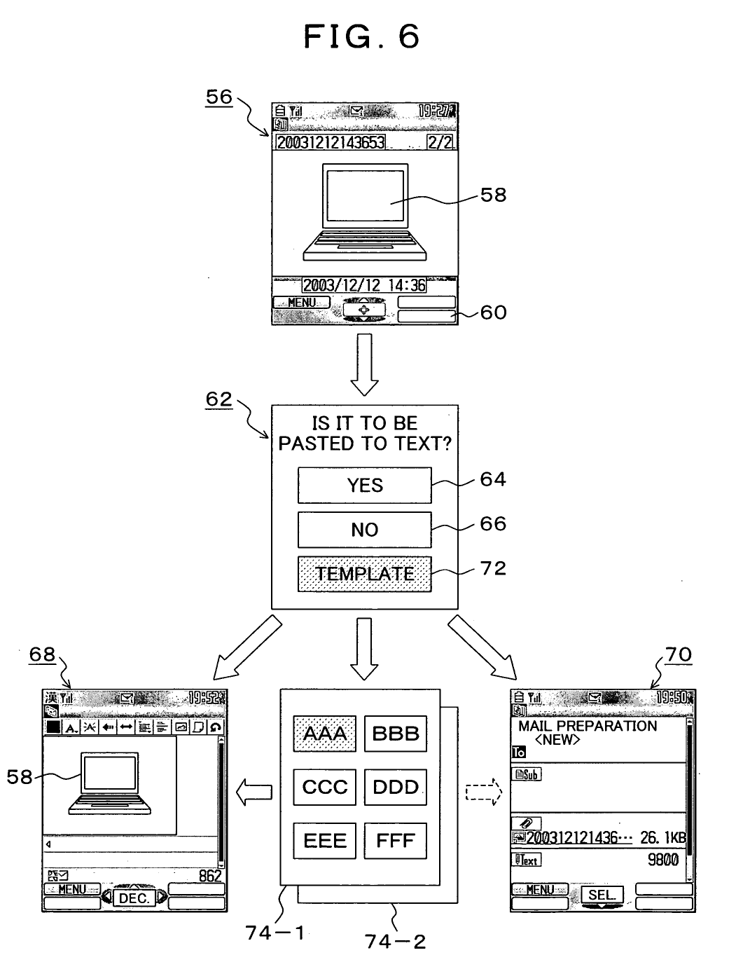

FIG. 6 is a descriptive view of the mail deploying processing according to the present invention for dialog-selecting a template. In the mail deploying processing shown in FIG. 6, upon deciding a selected image 56 through image selection on the image selecting screen 58, the dialog 62 is displayed by operating the soft key 60. In this embodiment, a template selecting window 72 is newly provided in addition to the inline attachment selecting window 64 and the simple attachment selecting window 66.

When the template selecting window 72 is selected through a selecting operation and a deciding operation by the use of a decision key 15 for the dialog 62, and operated, an HTML template list 74-1 shown therebelow is displayed. The template list includes an HTML template list 74-1 and a text template 74-2 to permit selection of any of them by switching on the list screen.

Since the HTML template list 74-1 is currently displayed, when an appropriate one is selected from among these templates, an HTML mail preparing screen 68 in conformity to the contents of the template is deployed by the mail application 32, and the selected image 56 is pasted at a position specified in the selected template.

When any of the templates is selected by displaying the text template list 74-2, the text mail preparing screen 70 is displayed by the activation of the mail application 32. In this case, the selected image 56 is simple-attached. When a position for pasting the image is not specified in the template selected from the HTML template list 74-1, the image is pasted at the end.

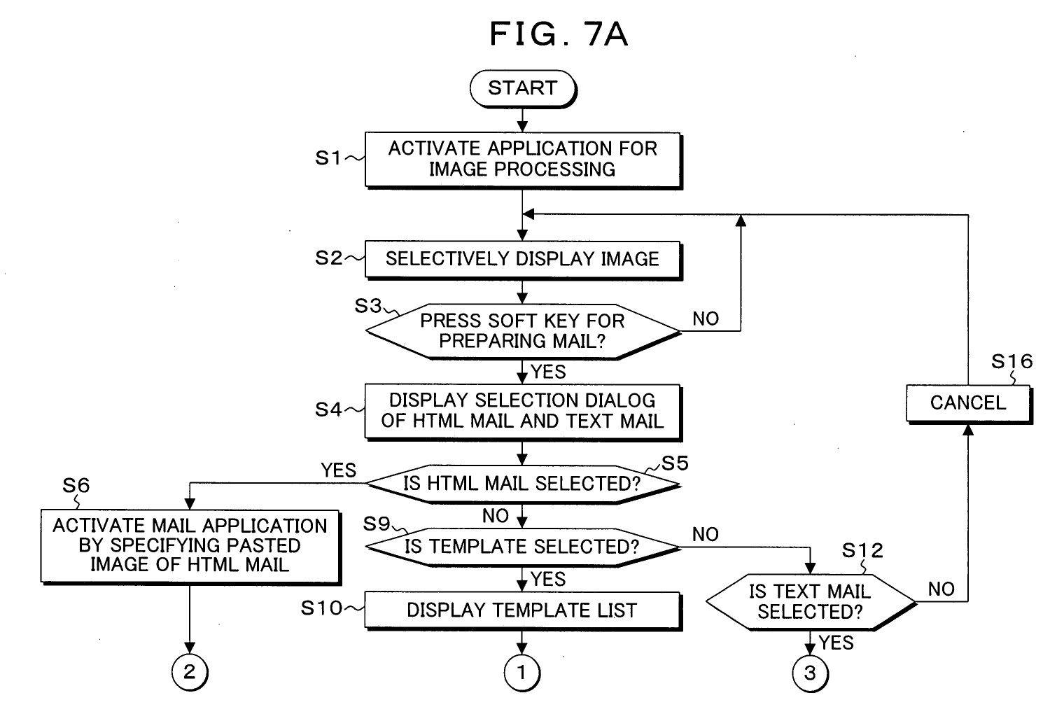

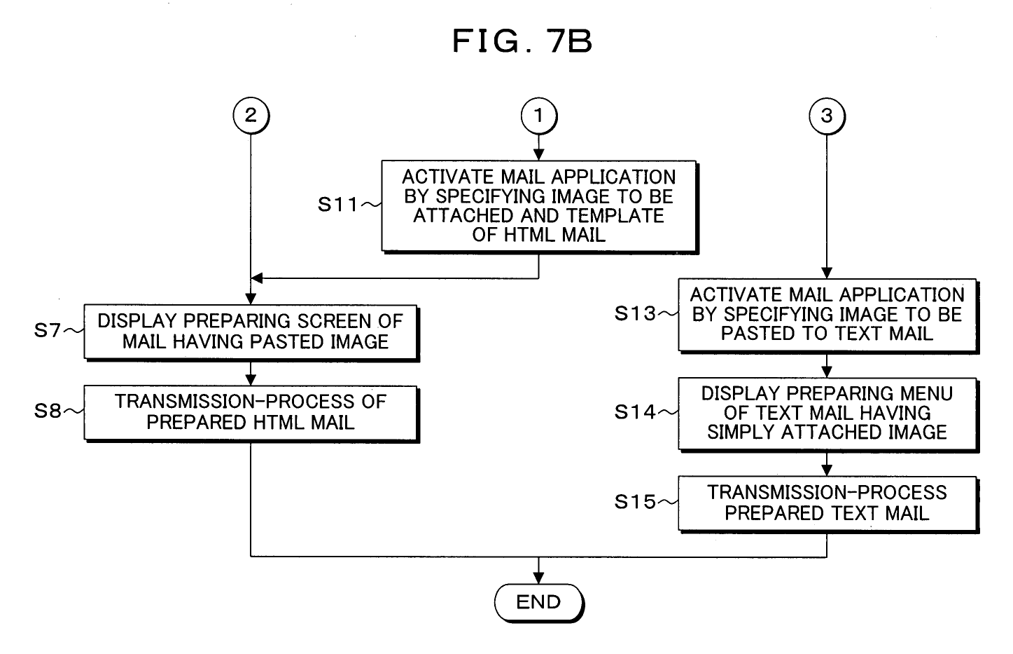

FIG. 7 is a flowchart of the mail deploying processing in the present invention corresponding to FIG. 6. In FIG. 7, the application for image processing is activated in step S1, and an image to be used for a mail is selection-displayed in step S2. In step S3, the soft key 60 for mail preparation is pressed down. Then in step S4, selecting dialogs of the HTML mail, the text mail and the template are displayed.

When selection of the HTML mail is determined from the dialog in step S5 thereafter, the process advances to step S6, in which the mail application is activated by specifying an image to be pasted in the HTML mail. In step S7, the preparing screen of the mail having the pasted image is displayed, and in step S8, the main text of the HTML mail is prepared and transmitted.

When template selection is determined in step S9, the template list is displayed in step S10. In this display of the template list, the HTML template list is first displayed, and as required, this can be switched over to display of the text template list. To simplify the description of the flowchart, a case where only the HTML template list is displayed is taken up.

When an arbitrary template is selected in this state of display of the HTML template list, the mail application 32 is activated by specifying an image to be pasted to the HTML mail and a template to be used in step S11. In step S7, the mail preparing screen of the selection template having the pasted image is displayed. In step S8, an HTML mail main text is prepared and transmitted.

When the text mail is selected in step S12, the mail application 32 is activated by specifying an attached image of the text mail in step S13, and thereafter in step S14, a preparing screen of a text mail having a simple-attached image is displayed, and in step S15, a text mail main text is prepared and transmitted.

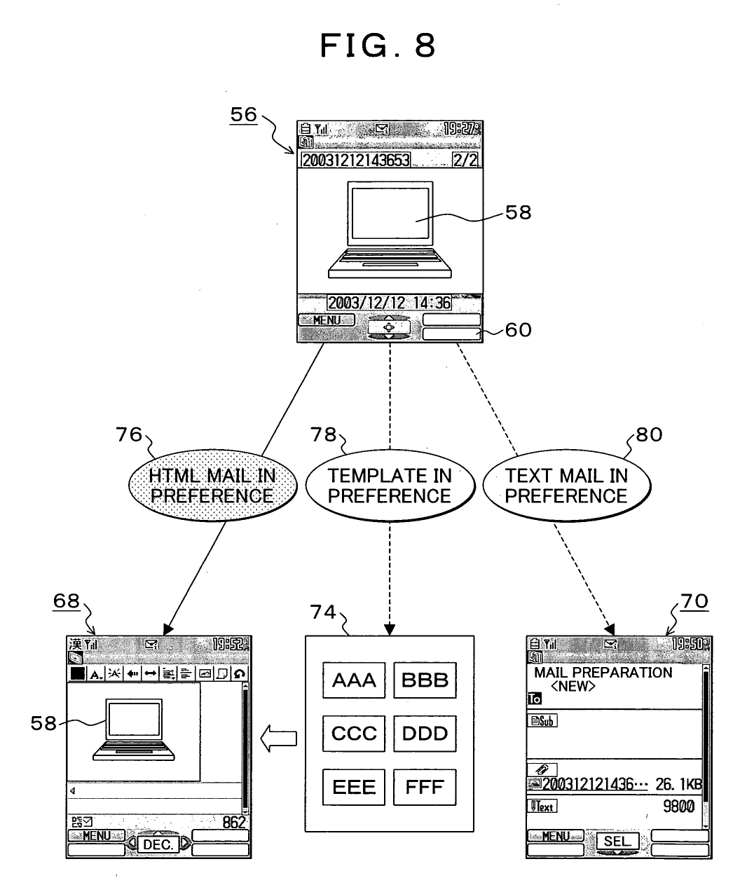

FIG. 8 is a descriptive view of the mail deploying processing according to the present invention in which an HTML mail or a text mail is automatically selected. In FIG. 8, prior to the processing of selecting an image to be used in the mail in the image selecting screen 58 of the image content application such as an image viewer, the user registers a preferential selection mode of the mail preparing screen using the image in advance. The preferential modes thus registered in advance include:
(1) HTML mail in preference
(2) Template in preference
(3) Text mail in preference
(4) No priority

When setting of such a preferential mode for mail preparation is registered in advance, pressing of the soft key 60 of the image selecting screen 58 in which a selected image has been decided leads to determination of the HTML mail in preference 76. The HTML mail preparing screen is automatically deployed without the necessity for selection by dialog display, and at the same time, the selected image 56 is pasted to the mail main text.

When the template in preference 78 based on a prior registration is determined, the HTML template list 74 is displayed, and by selecting any of the displayed templates, the HTML mail preparing screen 68 corresponding to the template is displayed.

When the text mail in preference 80 based on a prior registration is determined, the text mail preparing screen 70 is displayed. In the case of “no priority”, the dialog 62 is displayed as shown in FIG. 6.

When “template in preference” 78 is registered in advance in this case, the HTML template list 74-1 is displayed. A text template list which can be switched over by the selecting operation of the template list may be provided so that the text mail preparing screen 70 is opened from the template also for the ext mail.

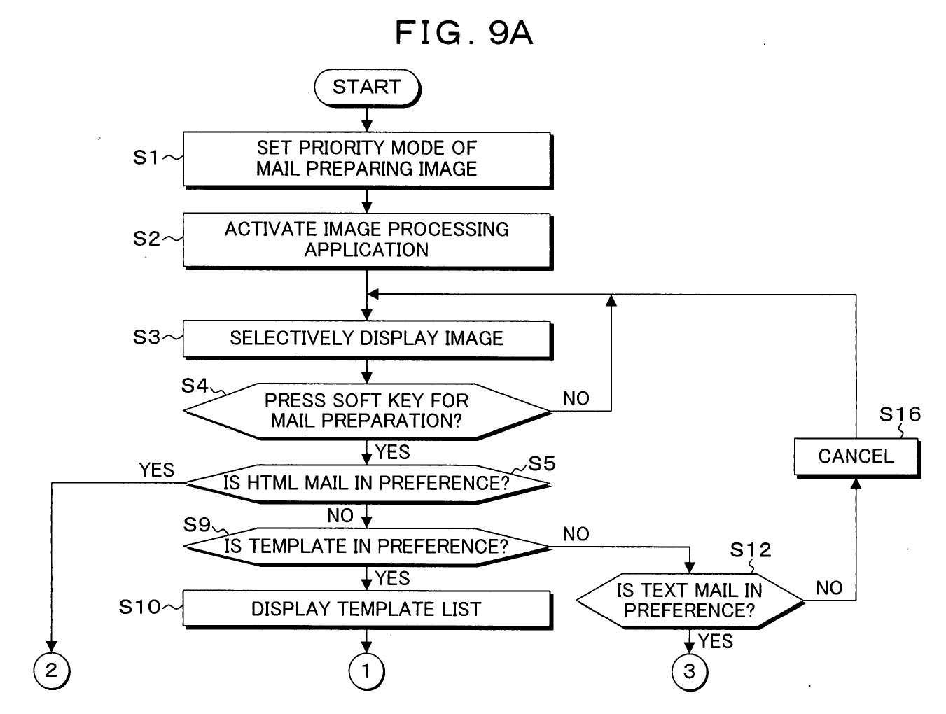

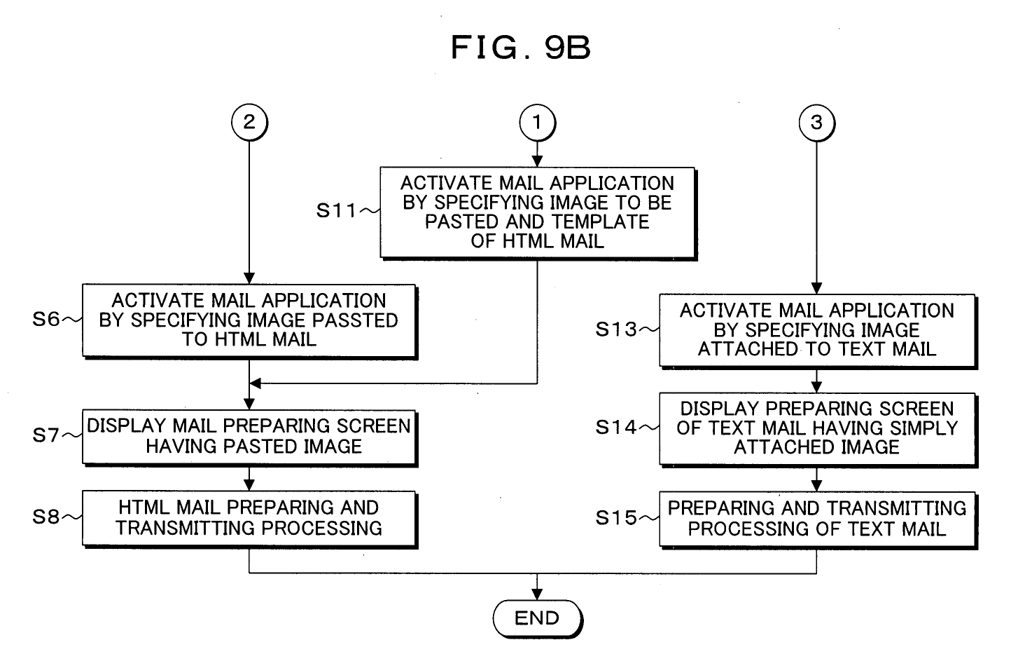

FIG. 9 is a flowchart of the mail deploying processing according to the present invention corresponding to FIG. 8. In FIG. 9, in step S1, the prior mode of the mail preparing screen is set in advance. This prior mode is any of the HTML mail in preference mode, the template in preference ode, the text mail in preference mode and the “no priority”, as shown in FIG. 8.

When the preference mode of the mail preparing screen is registered in advance, in the step S2 and subsequent steps, the image selection and display are carried out in step S3. When pressing of the mail preparing soft key 60 is determined in step S4, the dialog is displayed in the above-mentioned embodiments. In this embodiment, however, the dialog is not displayed, but the mail preparing screen is automatically deployed in accordance with the prior mode set in step S1.

More specifically, when the preference of the HTML mail is determined in step S5, the HTML mail preparing screen is deployed and the image is pasted in steps S6 to S8. When the preference of template is determined in step S9, the template list is displayed in step S10. In step S11, after activating the mail application is activated for deploying the HTML mail preparing screen corresponding to the selected template list, processes of steps S6 to S8 are carried out.

Furthermore, when the preference of text mail is determined in step S12, the text mail preparing screen is displayed through processes of steps S13 to S14, and the mail is prepared and transmitted with the selected image simple-attached.

In the flowchart of FIG. 9, processing is omitted for cases without priority. In this case, the dialog is displayed. The HTML mail template or the text mail is selected from the dialog, and the image processed on the mail preparing screen and the mail main text is prepared and transmitted.

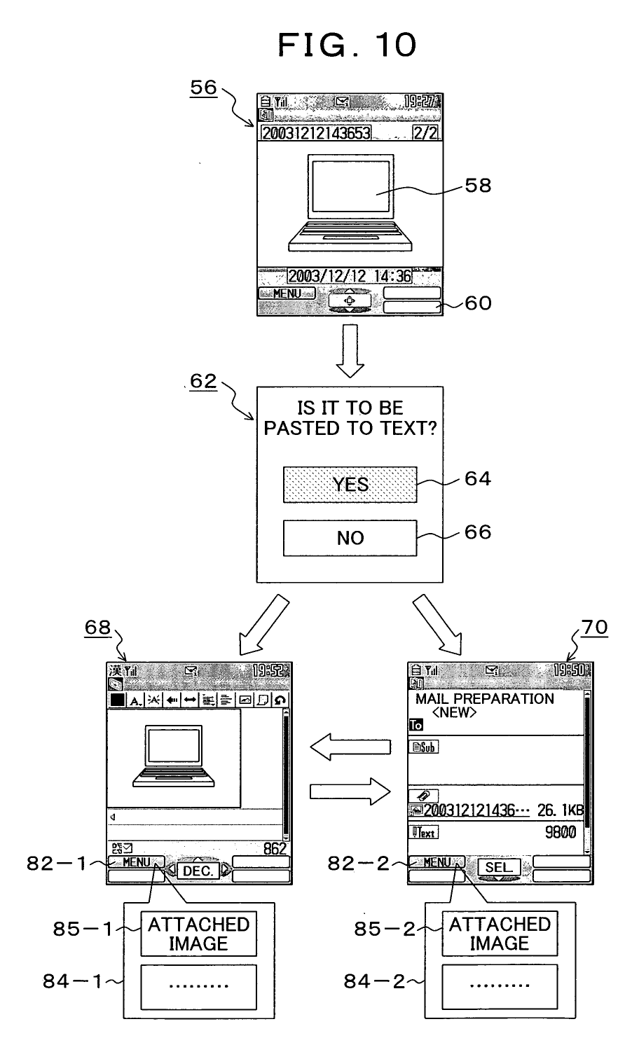

FIG. 10 is a descriptive view of the mail deploying processing according to the present invention in which switching is possible between the HTML mail and the text mail on the mail preparing screen. In the mail deploying processing shown in FIG. 10, when the soft key 60 of the image selecting screen 58 is pressed down after deciding a selected image 56 used in the mail, the dialog is displayed. When the inline-attachment selection window 64 is selection-operated, the HTML mail preparing screen 68 is displayed, and the selected image 56 is pasted. When the simple-attachment selecting window 66 is selection-operated, the text mail preparing screen 70 is displayed, and the selected image 56 is switched over to simple attachment.

In this HTML mail preparing screen 68, when the menu 82-1 is opened, a switching window 85-1 showing switching from inline attachment of pasting the image to the current main mail text to simple attachment is displayed in the menu screen. By selecting and operating the switching window 85-1, the screen is switched over to the text mail preparing screen. In this case, the image is switched over from an image pasted to the main mail text to a simple-attached image.

Also for the text mail preparing screen 70, when opening the menu screen 84-2 by operating the menu 82-2, the switching window 85-2 for the HTML mail preparing screen 68 is displayed in it. Therefore, when the switching window 85-2 is selected and operated for the menu screen 84-2, the screen is switched over to the HTML mail preparing screen 68, and the selected image is pasted to the mail main text.

According to the embodiment shown in FIG. 10, as described above, an image used for the mail is selected from the image content application. After selecting a mail preparing screen of any of an HTML mail with an pasted image or a text mail with a simple-attached image, the user can switch over the mail preparing screen between HTML mail and text mail as required, and thus can freely decide which of pasting of the image to the mail main text and simple attachment of the image is to be adopted during the mail preparing process.

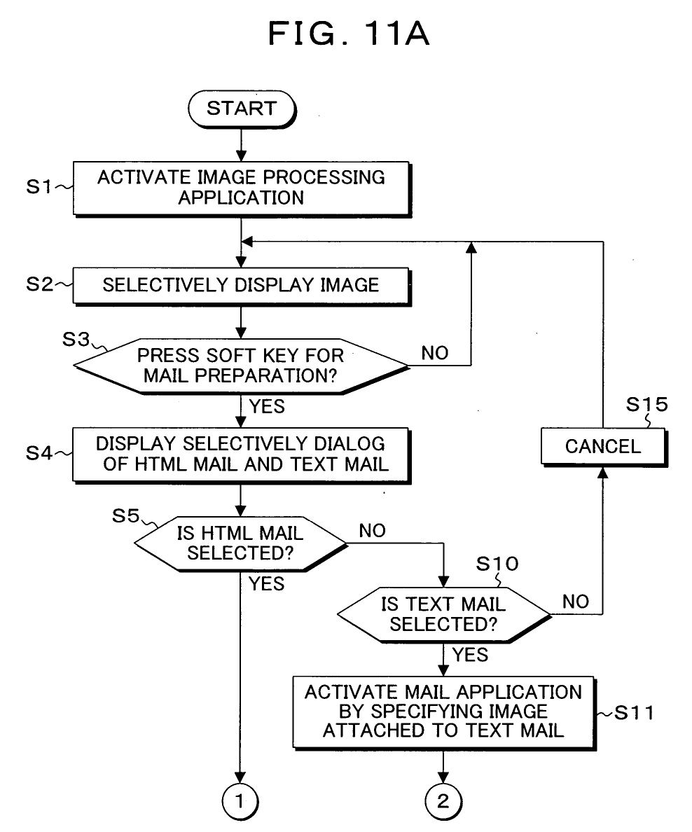

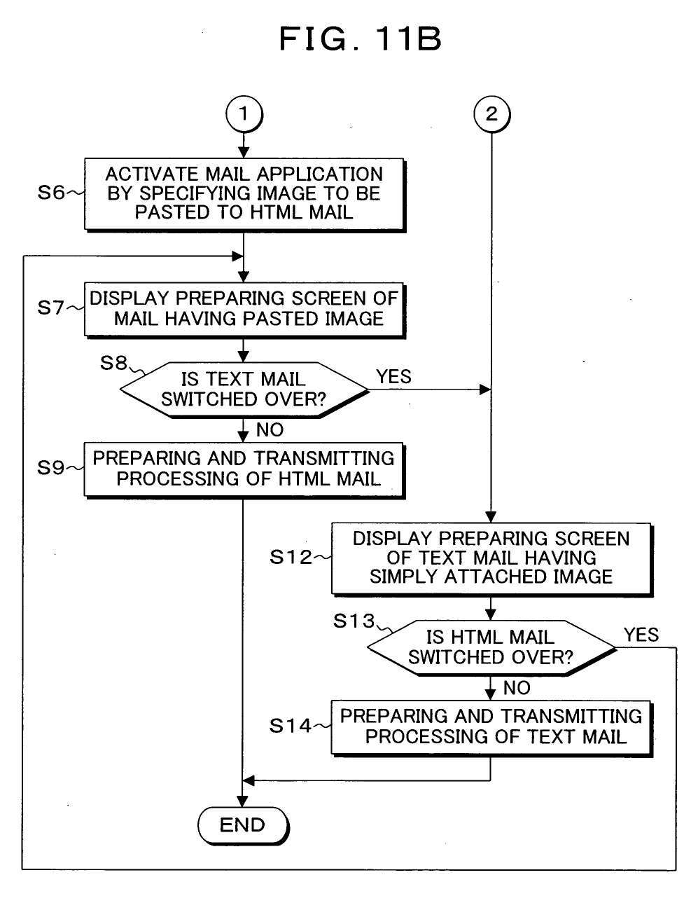

FIG. 11 is a flowchart of the mail deploying processing according to the present invention corresponding to FIG. 10. In the flowchart of FIG. 11, determination of text mail switching in step S8 and determination of switching of HTML mail in step S13 are added, the other processes being the same as in the flowchart of FIG. 5.

That is, when switching to text mail by the menu selection is determined in step S8 in a state in which the HTML mail preparing screen with a pasted image is displayed in step S7, the process advances to step S12, and a preparing screen of a text mail having a simple-attached image is displayed. On the other hand, in the display state of the preparing screen of the text mail having a simple-attached image, when switching to HTML mail in step S113 by menu selection is determined, the process goes to step S7, and the HTML mail preparing screen with an image pasted to the main mail text is displayed.

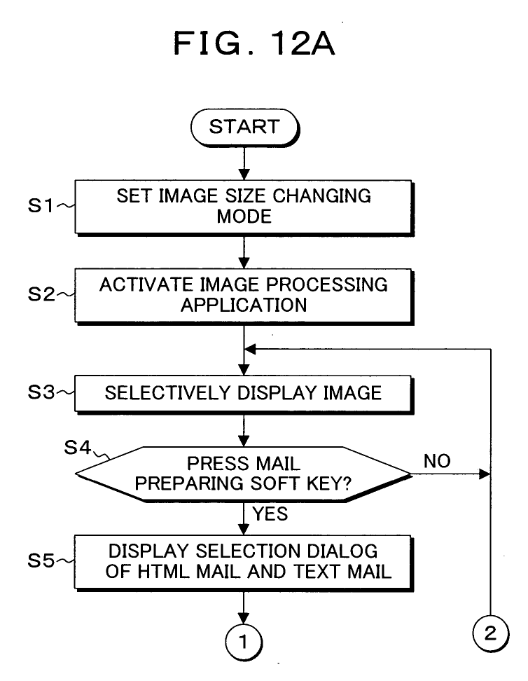

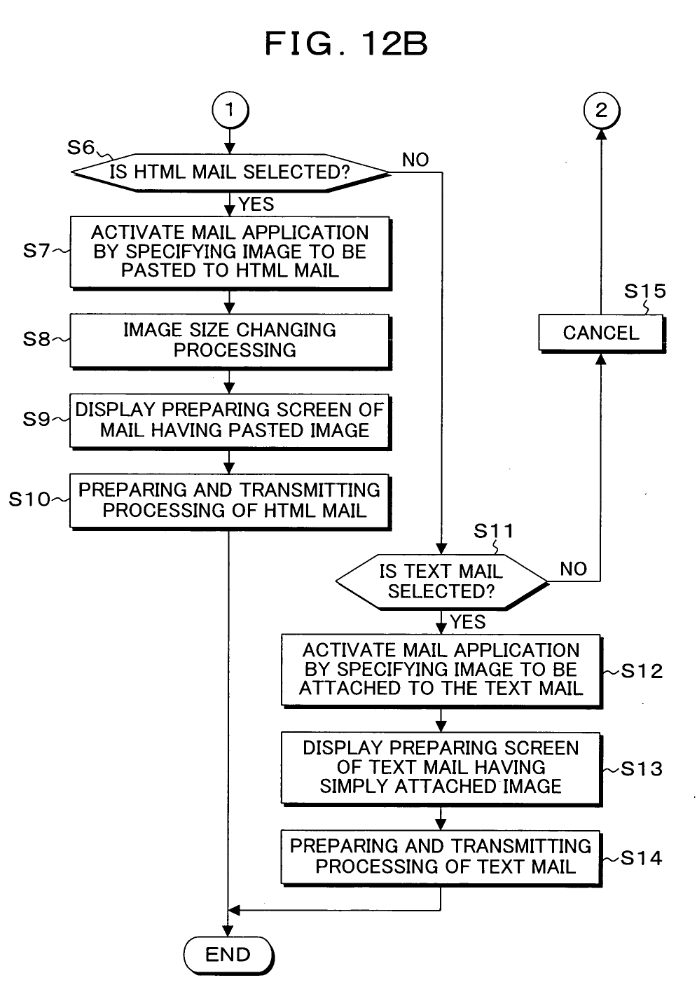

FIG. 12 is a flowchart of the mail deploying processing according to the present invention in which the size of an image selected in the mail preparing screen is automatically changed. In the mail deploying processing shown in FIG. 12, the changing mode of the image size is set through a prior registration in step S1. More specifically, in a cell phone, the image displayed on the display is of the upright type QVGA (Quarter Video Graphics Arrays) having an image size of 320×240 dots.

Therefore, image portion wider than 240 dots are not necessary. For an image having a width over 240 dots, the size can be automatically change upon pasting to the main mail text of the HTML mail.

For automatic size changing processing in this case, the following modes can be registered in advance:
(1) Automatic image size reducing mode: Reducing the image to a width of 240 dots without changing the aspect ratio.
(2) Automatic image cutting: As measured from the center of the image, each 120 dots to the right and left, 240 dots in total are cut without changing the aspect ratio.
(3) No change.

In the case of no change, inquiry is required upon viewing the mail preparing screen by opening the dialog.

When the size changing function of image to be pasted to such an HTML mail has been registered in advance in step S1, and when selection of the HTML mail is determined in step S6, the changing processing to the image size previously registered in step S8 is executed after activating the mail application in step S7, and in step S9, the size-changed image is pasted to the HTML mail and the preparing screen of the HTML mail is displayed in.

Except for these processes of steps S1 and S8 resulting from the image size changing mode, the processes are the same as in the flowchart of FIG. 4.

The present invention provides a program used for mail preparing processing of a cell phone. This program has details of processing corresponding to the flowcharts of FIGS. 5, 7, 9, 11 and 12.

The above-mentioned embodiments have covered a cell phone as the cell-phone terminal device. The present invention is applicable with no modification to relevant devices having mail applications corresponding to image pasting to the main mail text by an HTML mail such as a PDA, cell-phone terminal devices and the like.

In the above-mentioned embodiments, the mail preparing screen is displayed by main mail text having a pasted image or a mail having a simple-attached image, by displaying the dialog by pressing the soft key on the image selecting screen. The processing may be conducted so that the mail preparing screen is deployed from the sub-menu by means of pasting of image to the main mail text or simple attachment of an image to the main mail text, without displaying the dialog.

Furthermore, the present invention includes appropriate variations without impairing the object and advantages thereof, and is not restricted by numerical values shown in the above-mentioned embodiments.

The features of the present invention are as described in the following claims.

1. A cell-phone terminal device comprising:
a mail processing unit for preparing and transmitting a
mail of the multi-part format, comprising any or both of the NTML part which permits preparation of main mail text and an image of the main mail text, and text part comprising only the mail main text, and a selection attached file permitting attachment of an image;
an image processing unit which selects an image, displays the selected image on the screen, and instructs preparation of said mail; and
a mail deployment unit which, upon receipt of an instruction for preparing a mail from said image processing unit, permits deployment of a mail preparing screen by inline-attaching for pasting the image to the main mail text.

2. The cell-phone terminal device according to claim 1, having a storage unit capable of registering inline attachment in preference in which said inline attachment is executed in preference or simple attachment in preference in which said image is simply attached to the main mail text in preference; wherein
in said mail deployment unit, when any of said inline attachment in preference or said simple attachment in preference is registered in advance, a mail preparing screen corresponding to the contents of priority of said registration in advance is deployed.

3. The cell-phone terminal device according to claim 1, wherein, when mail switching is selected from the menu in a deployed state of the mail preparing screen by said deployment unit, the mail preparing screen of said inline attachment can be switched over to the mail preparing screen of said simple attachment.

4. The cell-phone terminal device according to claim 1, wherein, when a size change of a selected image has been registered in advance, a mail preparing screen pasted or attached with said size-changed selected image is deployed upon operating said software key.

5. A mail processing method of a cell-phone terminal device which prepares and transmits an HTML mail of a multi-part format comprising a main mail text, any or both of an HTML part permitting pasting of an image and a text part comprising a main mail text alone, and selective attached files permitting attachment of an image; said method comprising:
an image processing step which selects an image for display on a screen and instructs preparation of said mail; and
a mail deploying step which, upon receipt of an instruction to prepare a mail from said image processing step, performs an inline attachment of pasting the image onto the main mail text for deployment of a mail preparing screen.

6. The mail processing method of a cell-phone terminal device according to claim 5, wherein, when any of said inline attachment in preference and said simple attachment in preference is registered in advance, said mail deploying step deploys a mail preparing screen corresponding to details of preference of said prior registration without displaying said dialog upon operating said software key.

7. The mail processing method of a cell-phone terminal device according to claim 5, wherein, when mail switching is selected from the menu in the deployed state of the mail preparing screen in said mail deploying step, said mail switching step makes it possible to switch over a mail preparing screen of said inline attachment to a mail preparing screen of said simple attachment, and switch over a mail preparing screen of said simple attachment, to a mail preparing screen of said inline attachment.

8. The mail processing method of a cell-phone terminal device according to claim 5, wherein, when a size change of a selected image is registered in advance, said mail deploying step deploys a mail preparing screen pasted or attached with said size-changed selected image upon operating said software key.

9. A program which causes a computer of a cell-phone terminal device which prepares and transmits an HTML mail of a multi-part format comprising a main mail text, any or both of an HTML part permitting pasting of an image and a text part comprising a main mail text alone, and selective attached files permitting attachment of an image to execute:
an image processing.step which selects an image for display on a screen and instructs preparation of said mail; and
a mail deploying step which, upon receipt of an instruction to prepare a mail from said image processing step, performs an inline attachment of pasting the image onto the main mail text for deployment of a mail preparing screen.

10. The program according to claim 9, wherein, when any of said inline attachment in preference and said simple attachment in preference has been registered in advance, said mail deploying step deploys a mail preparing screen corresponding to the details of preference of said prior registration without displaying said dialog upon operating said software key.

11. The program according to claim 9, wherein mail switching is selected from the menu inn the deployed state of the mail preparing screen in said mail deploying step, said mail switching step makes it possible to switch over a mail preparing screen of said inline attachment to a mail preparing screen of said simple attachment, and switch over a mail preparing screen of said simple attachment, to a mail preparing screen of said inline attachment.

12. The program according to claim 9, wherein, when a size change of a selected image is registered in advance, said mail deploying step deploys a mail preparing screen pasted or attached with said size-changed selected image upon operating said software key.
